(19) United States
(12) Patent Application Publication
(10) Pub. No.: US 2018/0139329 A1
(43) Pub. Date: May 17, 2018

(54) TECHNIQUES FOR TRANSFERRING A CALL REGARDLESS OF CALL STATE FOR USER EQUIPMENT SHARING A MOBILE DEVICE NUMBER

(71) Applicant: QUALCOMM Incorporated, San Diego, CA (US)

(72) Inventors: Cherng-Shung HSU, San Diego, CA (US); Srinivasan Balasubramanian, San Diego, CA (US); Ramachandran Subramanian, San Diego, CA (US); Arvind Santhanam, San Diego, CA (US); Min Wang, San Diego, CA (US)

(21) Appl. No.: 15/353,151

(22) Filed: Nov. 16, 2016

(51) Int. Cl. H04M 3/58; H04M 1/725; H04L 29/06; H04L 5/00

(52) U.S. Cl. CPC H04M 3/58; H04M 1/72513; H04L 5/0055; H04L 65/1016; H04L 65/1006

(57) ABSTRACT

A method, an apparatus, and a computer program product for wireless communication are provided. A first user equipment (UE) may determine that the first UE is to transfer a call from the first UE to a second UE, wherein the first UE and the second UE share a mobile device number (MDN). The first UE may initiate a call transfer procedure to transfer the call from the first UE to the second UE while the call is in an active state.

### BACKGROUND

### Field

The present disclosure relates generally to communication systems, and more particularly, to techniques and apparatuses for transferring a call regardless of call state for user equipment sharing a mobile device number.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, an apparatus, an application server, and a computer program product are provided.

In some aspects, the method may include determining, by a first user equipment (UE), that the first UE is to transfer a call from the first UE to a second UE, wherein the first UE and the second UE share a mobile device number (MDN). The method may include initiating, by the first UE, a call transfer procedure to transfer the call from the first UE to the second UE while the call is in an active state.

In some aspects, the apparatus may include a memory and at least one processor coupled to the memory and configured to determine that the apparatus is to transfer a call from the apparatus to a target apparatus, wherein the apparatus and the target apparatus share a mobile device number (MDN). The at least one processor may be configured to initiate a call transfer procedure to transfer the call from the apparatus to the target apparatus while the call is in an active state.

In some aspects, the apparatus may include means for determining that the apparatus is to transfer a call from the apparatus to a target apparatus, wherein the apparatus and the target apparatus share a mobile device number (MDN). The apparatus may include means for initiating a call transfer procedure to transfer the call from the apparatus to the target apparatus while the call is in an active state.

In some aspects, the computer program product may include a non-transitory computer-readable medium storing computer executable code for wireless communication. The code may include code for determining, by a first user equipment (UE), that the first UE is to transfer a call from the first UE to a second UE, wherein the first UE and the second UE share a mobile device number (MDN). The code may include code for initiating, by the first UE, a call transfer procedure to transfer the call from the first UE to the second UE while the call is in an active state.

In some aspects, the method may include determining, by an application server, that a call is to be transferred from a first user equipment (UE) to a second UE, wherein the first UE and the second UE share a mobile device number (MDN). The method may include transferring, by the application server, the call from the first UE to the second UE while the call is in an active state.

In some aspects, the application server may include a memory and at least one processor coupled to the memory and configured to determine that a call is to be transferred from a first user equipment (UE) to a second UE, wherein the first UE and the second UE share a mobile device number (MDN). The at least one processor may be configured to transfer the call from the first UE to the second UE while the call is in an active state.

In some aspects, the application server may include means for determining that a call is to be transferred from a first user equipment (UE) to a second UE, wherein the first UE and the second UE share a mobile device number (MDN). The application server may include means for transferring the call from the first UE to the second UE while the call is in an active state.

In some aspects, the computer program product may include a non-transitory computer-readable medium storing computer executable code for wireless communication. The code may include code for determining, by an application server, that a call is to be transferred from a first user equipment (UE) to a second UE, wherein the first UE and the second UE share a mobile device number (MDN). The code may include code for transferring, by the application server, the call from the first UE to the second UE while the call is in an active state.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating an example system configured to transfer a call regardless of call state for user equipment sharing a mobile device number.

FIG. 8 is a flow chart of a method of wireless communication.

FIG. 9 is a flow chart of another method of wireless communication.

FIG. 10 is a conceptual data flow diagram illustrating the data flow between different modules/means/components in an example apparatus.

FIG. 11 is a diagram illustrating an example of a hardware implementation for an apparatus employing a processing system.

FIG. 12 is a conceptual data flow diagram illustrating the data flow between different modules/means/components in another example apparatus.

FIG. 13 is a diagram illustrating an example of a hardware implementation for another apparatus employing a processing system.

### DETAILED DESCRIPTION

The detailed description set forth below in connection with the appended drawings is intended as a description of various configurations and is not intended to represent the configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

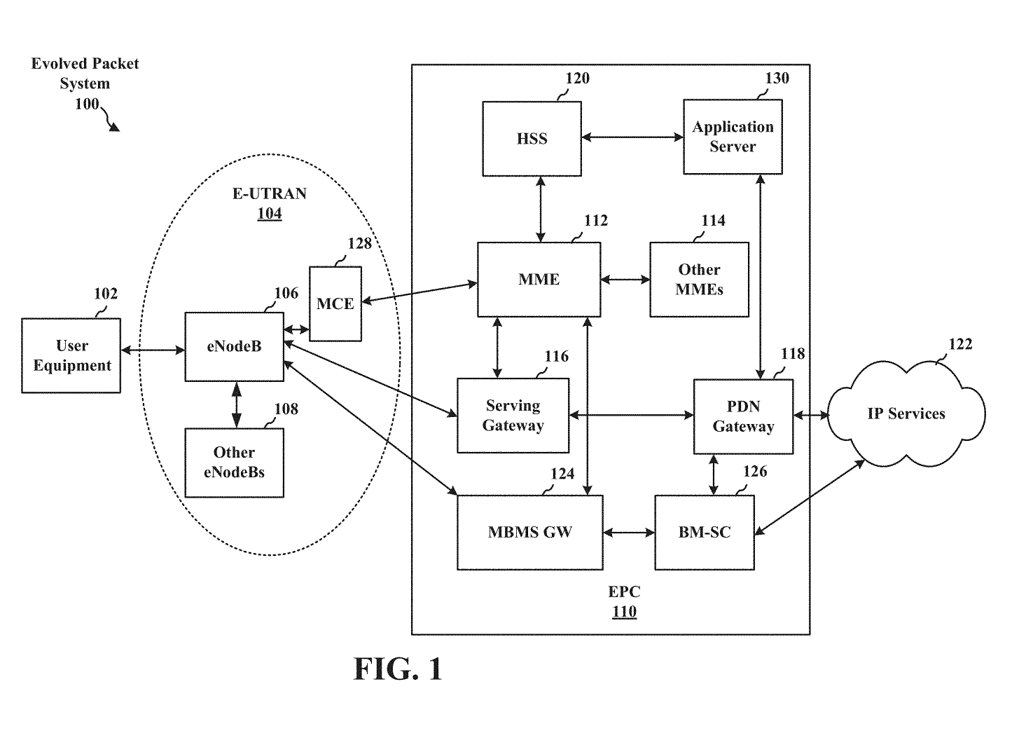

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, a Packet Data Network (PDN) Gateway 118, and an application server 130. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

The application server 130 may process and/or manage calls between the UEs 102. For example, the application server 130 may act as a back-to-back user agent to establish a first call dialog with a first UE 102 and a second call dialog with a second UE 102 to connect the first UE 102 and the second UE 102 on a call. In some aspects, the application server may include a call session control function (CSCF) device, and may be included in an IMS network.

FIG. 1 is provided as an example. Other examples are possible and may differ from what was described in connection with FIG. 1.

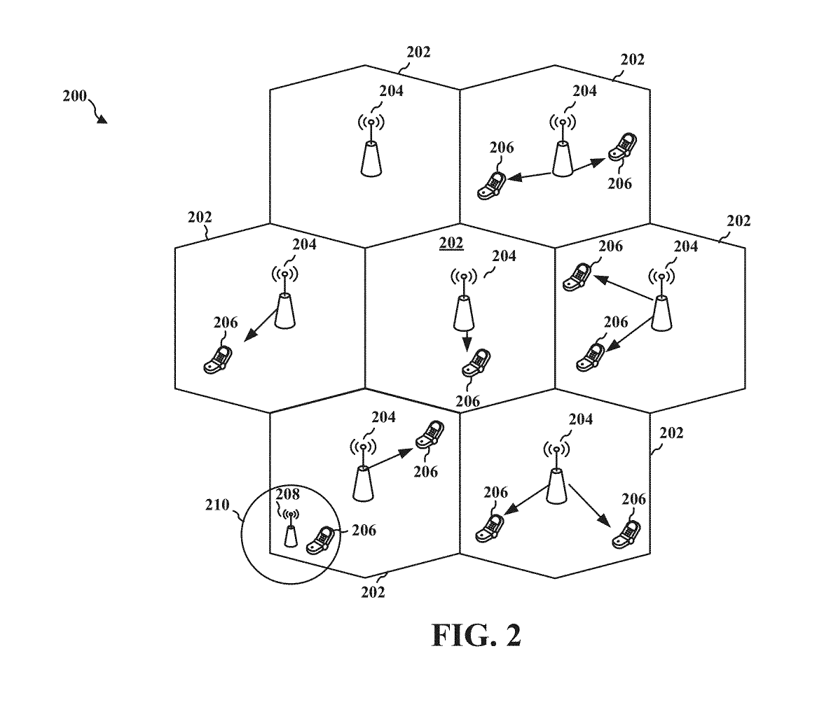

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving a particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

FIG. 2 is provided as an example. Other examples are possible and may differ from what was described in connection with FIG. 2.

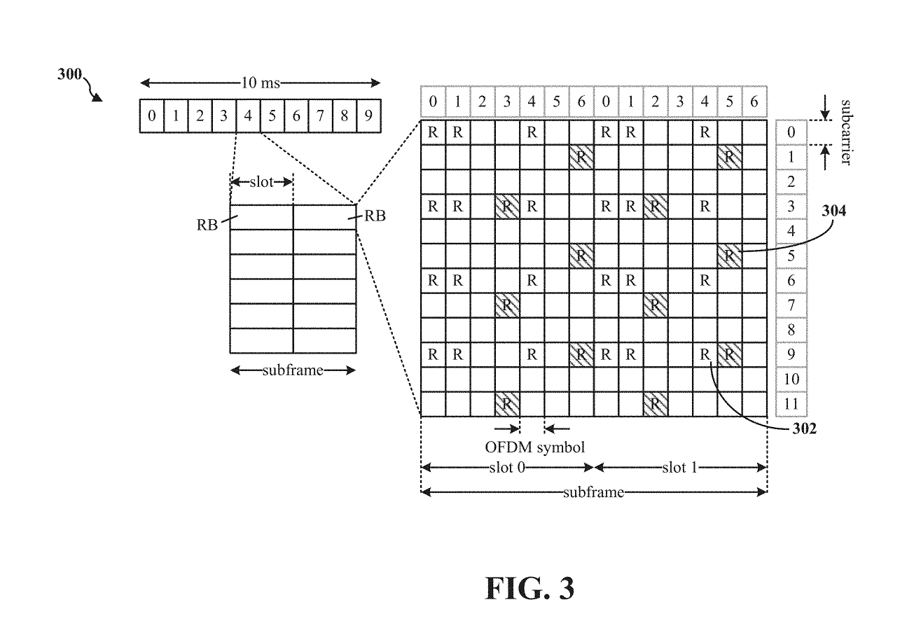

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

FIG. 3 is provided as an example. Other examples are possible and may differ from what was described in connection with FIG. 3.

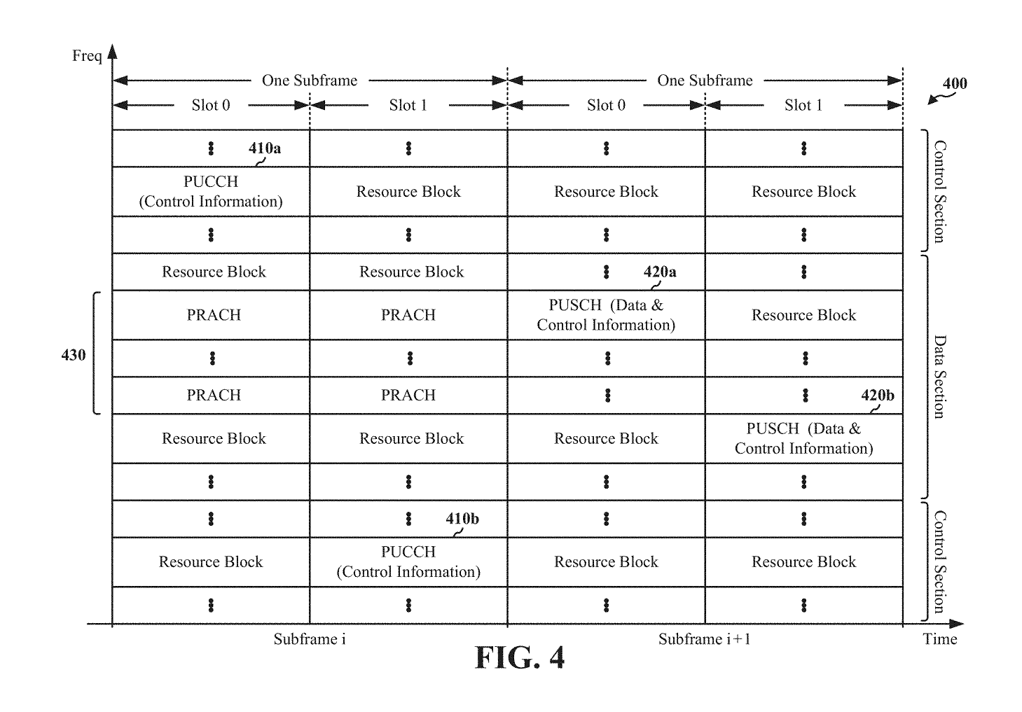

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make a single PRACH attempt per frame (10 ms).

FIG. 4 is provided as an example. Other examples are possible and may differ from what was described in connection with FIG. 4.

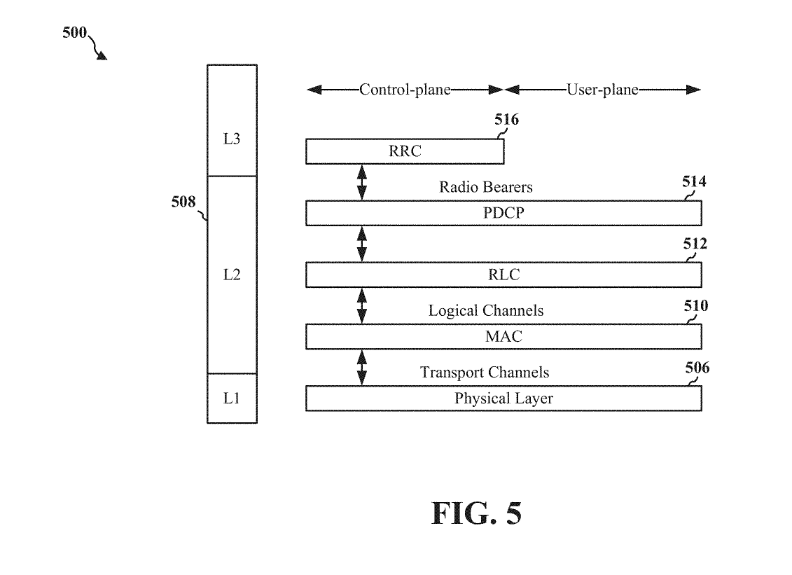

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

FIG. 5 is provided as an example. Other examples are possible and may differ from what was described in connection with FIG. 5.

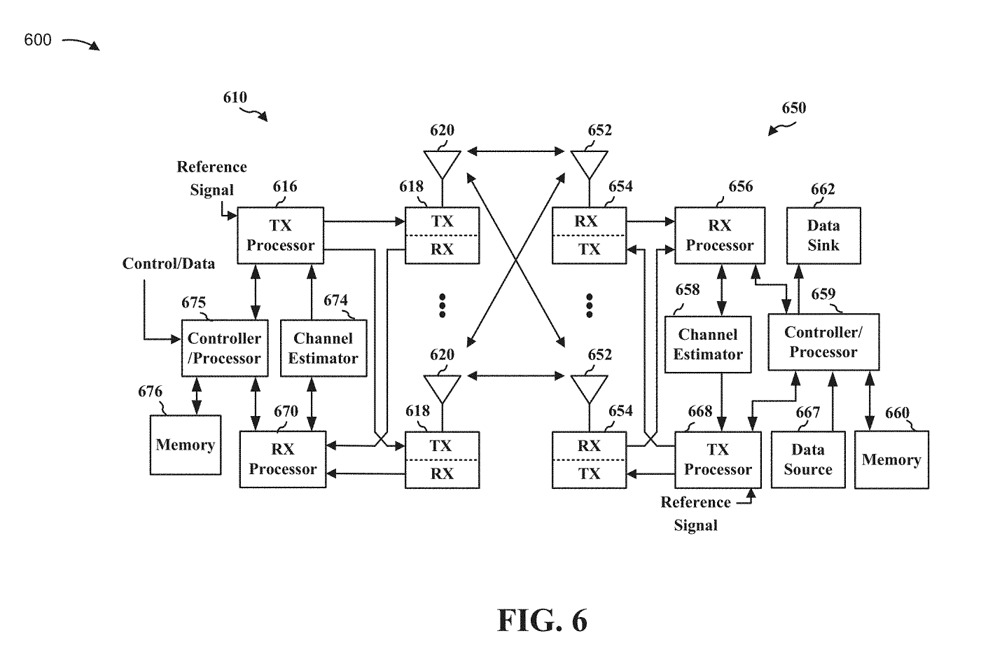

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based at least in part on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based at least in part on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based at least in part on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based at least in part on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

FIG. 6 is provided as an example. Other examples are possible and may differ from what was described in connection with FIG. 6.

A telephone number, such as a mobile directory number (MDN), may be shared by multiple UEs by registering the UEs with the shared MDN in an Internet Protocol Multimedia Subsystem (IMS) network. For example, a first UE, such as a mobile phone, may share an MDN with a second UE, such as a tablet computer. In this way, a user may use either device (e.g., the mobile phone or the tablet computer) to make and receive calls using a single MDN. In some cases, a user may want to transfer or push an ongoing call (e.g., a voice call and/or a video call) from a transferor UE (e.g., a first UE) to a target UE (e.g., a second UE) that shares an MDN with the transferor UE. For example, the user of the transferor UE may be connected on a call between the transferor UE and a transferee UE (e.g., a third UE), and may want to transfer the call from the transferor UE to the target UE so that the call is between the target UE and the transferee UE.

In order to transfer the call from a transferor UE to a target UE that shares an MDN with the transferor UE, the call may need to be placed on hold (e.g., an inactive state), and the call may be transferred while the call is on hold (e.g., according to 3GPP TS 24.629). However, placing the call on hold prior to transfer and switching from a hold state to an active state after the transfer may increase the amount of time for the transfer, resulting in a poor user experience. Techniques and apparatuses described herein permit a call to be transferred regardless of a state of the call, so that the call can be transferred while the call is in an active state, thereby reducing an amount of time for the call transfer and improving the user experience.

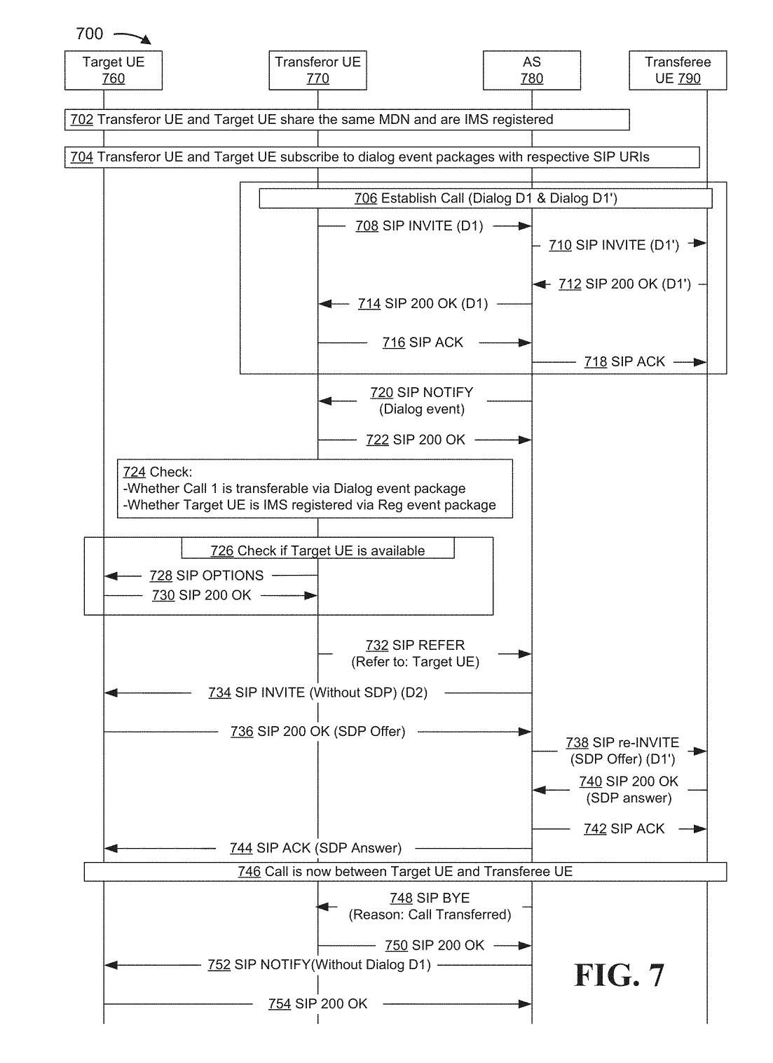

FIG. 7 is a diagram illustrating an example system 700 configured to transfer a call regardless of call state for user equipment sharing a mobile device number. As shown in FIG. 7, one or more operations 702-754 may be performed by a target UE 760, a transferor UE 770, an application server (AS) 780 (e.g., the AS 130 of FIG. 1), and/or a transferee UE 790. The target UE 760, the transferor UE 770, and/or the transferee UE 790 may correspond to one or more UEs described elsewhere herein (e.g., the UE 102 of FIG. 1, the UE 206 of FIG. 2, the UE 650 of FIG. 6, etc.). The AS 780 may include, for example, a call session control function (CSCF) device, and may be included in an IMS network. The AS 780 may act as a back-to-back user agent.

As shown by reference number 702, the transferor UE 770 and the target UE 760 may share the same MDN and may be registered with an IMS network. For example, the transferor UE 770 and the target UE 760 may be registered with feature tags indicating support for Voice over LTE calls (e.g., when the call to be transferred is a voice call), indicating support for video calls (e.g., when the call to be transferred is a video call), and/or indicating that the transferor UE 770 and the target UE 760 share an MDN. Additionally, or alternatively, the transferor UE 770 and the target UE 770 may be configured with a call transfer feature to permit transfer of calls.

As shown by reference number 704, the transferor UE 770 and the target UE 760 may subscribe to dialog event packages using their respective session initiation protocol (SIP) uniform resource identifiers (URIs). In order for a first user agent (e.g., a UE or an AS acting as a back-to-back user agent) to interact with a dialog (or call) of a second user agent, the second user agent publishes the state of the dialog(s) in which the second use agent is participating. The state of the dialog(s) may be published in a dialog event package. The first user agent can retrieve the second user agent's dialog event package to obtain the identifiers of the second user agent's dialogs, and can manipulate those dialogs using the identifiers.

For example, the transferor UE 770 may subscribe to the dialog event package by sending a SIP SUBSCRIBE message to the IMS network. In the SIP SUBSCRIBE message, the transferor UE 770 may set the request URI, the From header, and the To header of the dialog event SIP SUBSCRIBE to the SIP URI that uniquely identifies the transferor UE 770. Similarly, the target UE 760 may set the request URI, the From header, and the To header of the dialog event SIP SUBSCRIBE to the SIP URI that uniquely identifies the target UE 760. The different SIP URIs of the transferor UE 770 and the target UE 760 may permit these devices to be differentiated from one another despite sharing an MDN.

In their respective SIP SUBSCRIBE messages, the transferor UE 770 and the target UE 760 may set the value of the Event header to “dialog” to indicate that the devices are subscribing to dialog events, may set the value of the Expires header to a value between 7200 and 1000060 seconds (e.g., with a default value of 7200) to indicate the duration of the subscription, and may indicate a respective international mobile equipment identity (IMEI) in the Contact header. In this way, the transferor UE 770 and the target UE 760 may subscribe to dialog events, thereby permitting receipt of dialog information related to call transfers.

As shown by reference number 706, the transferor UE 770 and the transferee UE 790 may establish a call with the assistance of the AS 780. The call may be, for example, a voice call, a video call, or the like. As shown, the call may include a first dialog D1 between the transferor UE 770 and the AS 780, and may include a second dialog D1′ between the AS 780 and the transferee UE 790.

As shown by reference number 708, to initiate the call, the transferee UE 770 may send a SIP INVITE message that identifies the transferee UE 790 as a destination for the call. The SIP INVITE message may be received by the AS 780.

As shown by reference number 710, the AS 780 may send a SIP INVITE message to the transferee UE 790. As shown by reference number 712, the transferee UE 790 may send a SIP 200 OK message to the AS 780 in response to the SIP INVITE message. As shown by reference number 714, the AS 780 may then send a SIP 200 OK message to the transferor UE 770. As shown by reference number 716, the transferor UE 770 may send a SIP acknowledgement (ACK) message to the AS 780. As shown by reference number 718, the AS 780 may send a SIP ACK message to the transferee UE 790. In this way, the call may be established between the transferor UE 770 and the transferee UE 790 with the AS 780 acting as a back-to-back user agent that maintains separate dialogs with each UE.

As shown by reference number 720, after the call is established, the AS 780 may send, to the transferor UE 770, a SIP NOTIFY message with a dialog event package. The AS 780 may send the dialog event package to the transferor UE 770 because the transferor UE 770 subscribed to receive dialog events, as described above. The dialog event package may include information associated with dialog D1 of the transferor UE 770. In some aspects, the dialog event package may include an indication of whether the dialog (e.g., the call) is capable of being transferred (e.g., whether the dialog or call is transferable). Additionally, or alternatively, the dialog event package may include information that identifies other UEs that share an MDN with the transferor UE 770. For example, the dialog event package may include a SIP URI for the target UE 760. Additionally, or alternatively, the dialog event package may include information as described in the Internet Engineering Task Force (IETF) Request for Comments (RFC) 4235. As shown by reference number 722, the transferor UE 770 may respond to the SIP NOTIFY message with a SIP 200 OK message.

As shown by reference number 724, the transferor UE 770 may use the dialog event package to determine whether the call is transferable. For example, the dialog event package may include an indication of whether the call (e.g., dialog D1 of the call) is transferable, as described above. Additionally, or alternatively, the transferor UE 770 may use a registration event package (e.g., to which the transferor UE 770 has previously subscribed) to determine whether the target UE 760 is registered with the IMS network. If the call is not transferable or the target UE 760 is not registered with the IMS network, then the transferor UE 770 may prevent a call transfer prompt from being displayed on the transferor UE 770, may prevent call transfer from being initiated, or the like. If the call is transferable and the target UE 760 is registered with the IMS network, then the transferor UE 770 may display a call transfer prompt. When a user interacts with the call transfer prompt, the transferor UE 770 may initiate a call transfer procedure to transfer the call from the transferor UE 770 to the target UE 760 while the call is in an active state (e.g., not on hold), as described below.

As shown by reference number 726, in some aspects, the transferor UE 770 may determine whether the target UE 760 is available to receive the call via the call transfer. For example, as shown by reference number 728, the transferor UE 770 may transmit a SIP OPTIONS message to the target UE 760 (e.g., via a network). The SIP OPTIONS message may be used to query the capabilities and/or availability of the target UE 760. As shown by reference number 730, the target UE 760 may respond to the SIP OPTIONS message with a SIP 200 OK message (e.g., a SIP OPTIONS query response) that indicates that the target UE 760 is available for the call transfer.

As shown by reference number 732, the transferor UE 770 may transmit a SIP REFER message to the AS 780 to initiate transfer of the call from the transferor UE 770 to the target UE 760 while the call is in an active state. For example, a user of the transferor UE 770 may interact with the transferor UE 770 (e.g., via touch input, voice input, etc.) to cause the transferor UE 770 to initiate transfer of the call. Based at least in part on determining that the call is to be transferred, the transferor UE 770 may transmit the SIP REFER message to the AS 780. The SIP REFER message may identify the target UE 760, such as by using a SIP URI of the target UE 760. For example, the transferor UE 770 may set a value of a Refer-to field, in the SIP REFER message, to the SIP URI of the target UE 760.

As shown by reference number 734, based at least in part on receiving the SIP REFER message that identifies the target UE 760, the AS 780 may transmit a SIP INVITE message to the target UE 760. The SIP INVITE message may be sent by the AS 780 without session description protocol (SDP) information (e.g., the SIP INVITE message may exclude SDP information). The SIP INVITE message may be sent on a third dialog D2 between the target UE 760 and the application server 780.

As shown by reference number 736, based at least in part on receiving the SIP INVITE message without SDP information, the target UE 760 may transmit a SIP 200 OK message, that includes an SDP offer, to the application server 780. The target UE 760 may include, in the SDP offer, the same information that would have been included in a SIP INVITE message had the target UE 760 been the originator of the transferred call, rather than the target for the transferred call (e.g., a voice call or a video call).

In some aspects, the target UE 760 may use information received in a dialog event package for dialog D1 (e.g., to which the target UE 760 previously subscribed and received from the AS 780 via a SIP NOTIFY message) to configure the SIP offer. For example, for a video call, the target UE 760 may set a value for the video direction (e.g., <mediaDirection>) to be the same as the value for the local video direction in the dialog event package for D1 (e.g., a value of “sendrecv,” “sendonly,” or “recvonly,” found in the <mediaDirection> element within the <local> element in the dialog event package). In this way, the video direction for a video call may be maintained after the call is transferred, thereby improving a user experience. Additionally, or alternatively, the target UE 760 may set a video port value to zero in the SDP offer if the dialog event package has a <port0/> element within the <mediaAttributes> element. This may permit a downgraded video call to be transferred. In some aspects, the target UE 760 may set an audio direction value to be “sendrecv” to permit two-way audio.

As shown by reference number 738, the AS 780 may transmit, to the transferee UE 790, a SIP re-INVITE message on dialog D1′. The SIP re-INVITE message may include the SDP offer from the target UE 760. As shown by reference number 740, the transferee UE 790 may transmit a SIP 200 OK message to the AS 780 in response to the SIP re-INVITE message. The SIP 200 OK message may include an SDP answer to the SDP offer, which may be used to complete the SDP negotiation between the target UE 760 and the transferee UE 790 for the transferred call.

As shown by reference number 742, the AS 780 may transmit a SIP ACK message to the transferee UE 790 in response to the SIP 200 OK message. As shown by reference number 744, the AS 780 may transmit a SIP ACK message to the target UE 760. This SIP ACK message may include the SDP answer received from the transferee UE 790, thereby completing SDP negotiation for the transferred call.

As shown by reference number 746, the call is now transferred from the transferor UE 770 to the target UE 760, and the call is between the target UE 760 and the transferee UE 790. By transmitting a SIP re-INVITE message over the existing dialog D1′ instead of transmitting a new SIP INVITE message from the target UE 760 to the transferee UE 790, the AS 780 is capable of transferring the call without placing the call on hold, thereby reducing call transfer time and improving a user experience. Further, AS 780 is capable of transferring the call regardless of a call state of the call (e.g., AS 780 may transfer the call when the call is in an active state or a hold state).

As shown by reference number 748, to terminate dialog D1 between the transferor UE 770 and the AS 780, the AS 780 transmits a SIP BYE message to the transferor UE 770. In some aspects, the SIP BYE message may indicate that a call transfer is the reason for the call termination. As shown by reference number 750, the transferor UE 770 may transmit a SIP 200 OK message to the AS 780 in response to the SIP BYE message, and the dialog D1 may be terminated after transferring the call.

As shown by reference number 752, the AS 780 may transmit a SIP NOTIFY message to the target UE 760 with updated dialog event information indicating that the dialog D1 has been terminated. For example, the SIP NOTIFY message may exclude dialog D1 information because dialog D1 has been terminated. As shown by reference number 754, the target UE 760 may respond to the SIP NOTIFY message with a SIP 200 OK message. In this way, the AS 780 may complete the call transfer procedure while the call is in an active state (e.g., without placing the call on hold), thereby reducing an amount of time for the call transfer procedure and improving a user experience.

While a call transfer procedure has been described as occurring while a call is in an active state, the call transfer procedure is also applicable for when the call is in an inactive (e.g., on hold) state. Thus, the call transfer procedure is applicable regardless of a state of the call (i.e., active or inactive).

FIG. 7 is provided as an example. Other examples are possible and may differ from what was described in connection with FIG. 7.

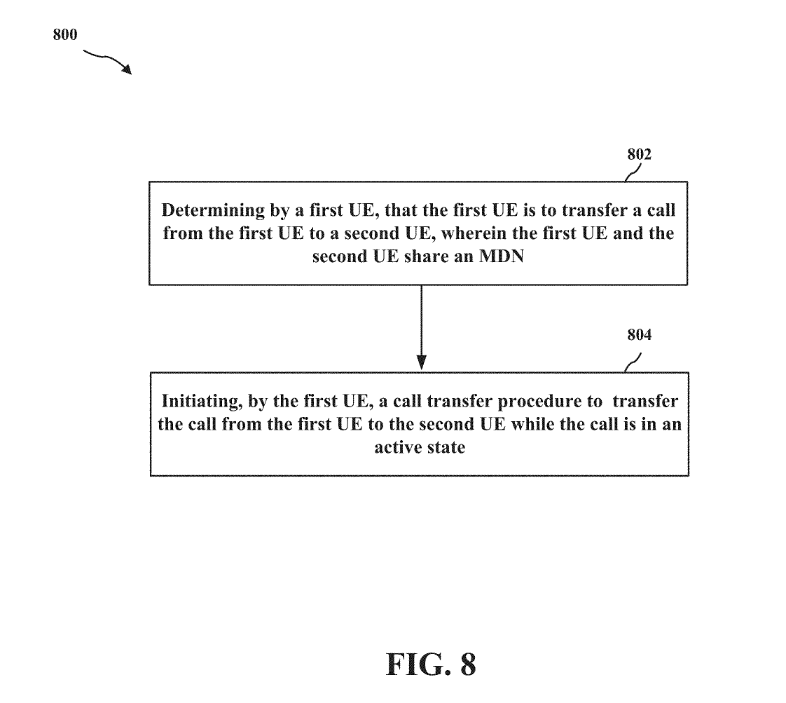

FIG. 8 is a flow chart 800 of a method of wireless communication. In some aspects, the method may be performed by a UE (e.g., the UE 102, the UE 206, the UE 650, the transferor UE 770, the apparatus 1002/1002′, etc.).

At 802, a first UE may determine that the first UE is to transfer a call from the first UE to a second UE, wherein the first UE and the second UE share an MDN. For example, referring to FIG. 7, the transferor UE 770 (e.g., the first UE) may receive user input indicating that a call is to be transferred from the transferor UE 770 to a target UE 760 (e.g., the second UE). The call may be, for example, a voice call or a video call between the transferor UE 770 and a transferee UE 790 (e.g., a third UE).

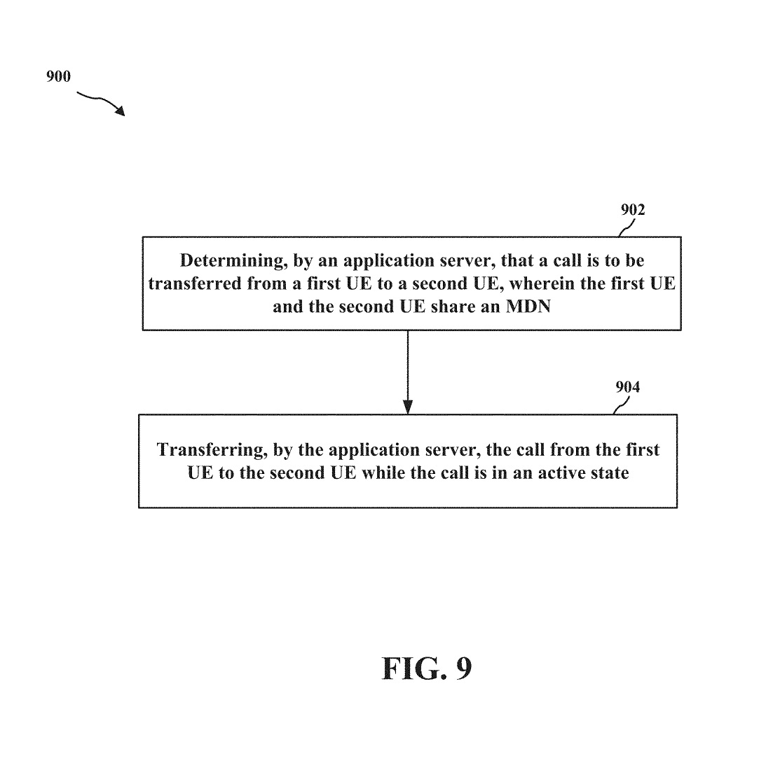

At 804, the first UE may initiate a call transfer procedure to transfer the call from the first UE to the second UE while the call is in an active state. For example, based at least in part on receiving the user input to transfer the call, the transferor UE 770 may initiate a call transfer procedure to transfer the call from the transferor UE 770 to the target UE 760 while maintaining the call in an active state (e.g., without placing the call on hold). In some aspects, the transferor UE 770 may initiate the call transfer procedure based at least in part on determining that the target UE 760 is available to receive the call, determining that the target UE 760 is registered with an IMS network, and/or determining that the call is transferable (e.g., using information included in a dialog event package received by the transferor UE 770). In some aspects, the transferor UE 770 may initiate the call by transmitting a SIP REFER message, that identifies the target UE 760 to AS 780. The AS 780 may then perform the call transfer procedure to transfer the call, as described in more detail below in connection with FIG. 9. The call transfer procedure may be initiated and/or performed while the call between the transferor UE 770 and the transferee UE 790 remains in an active state (e.g., without placing the call on hold), thereby reducing the call transfer time and improving the user experience.

Although FIG. 8 shows example blocks of a method of wireless communication, in some aspects, the method may include additional blocks, fewer blocks, different blocks, or differently arranged blocks than those shown in FIG. 8. Additionally, or alternatively, two or more blocks shown in FIG. 8 may be performed in parallel.

FIG. 9 is a flow chart 900 of a method of wireless communication. The method may be performed by an application server (e.g., the AS 780, the apparatus 1202/1202′, etc.).

At 902, the application server may determine that a call is to be transferred from a first UE to a second UE, wherein the first UE and the second UE share an MDN. For example, referring to FIG. 7, the AS 780 may receive an indication that a call is to be transferred from a transferor UE 770 (e.g., the first UE) to a target UE 760 (e.g., the second UE). The call may be, for example, a voice call or a video call between the transferor UE 770 and a transferee UE 790 (e.g., a third UE). The call may include a first dialog between the transferor UE 770 and the AS 780, and a second dialog between the transferee UE 790 and the AS 780. In some aspects, the AS 780 may determine that the call is to be transferred based at least in part on receiving a SIP REFER message from the transferor UE 770. The SIP REFER message may identify the target UE 760 as the target for the call transfer.

At 904, the application server may transfer the call from the first UE to the second UE while the call is in an active state. For example, the AS 780 may receive, from the transferor UE 770, the SIP REFER message identifying the target UE 760. Based at least in part on receiving the SIP REFER message, the AS 780 may transmit, to the target UE 760 via a third dialog, a SIP INVITE message without SDP information. The target UE 760 may receive the SIP INVITE message with SDP information, and may respond by transmitting an SDP offer to the AS 780. The AS 780 may then transmit, to the transferee UE 790 via the second dialog, a SIP re-INVITE message that includes the SDP offer. The transferee UE 790 may respond by transmitting an SDP answer to the AS 780, and the AS 780 may transmit the SDP answer to the target UE 760 to complete SDP negotiation and establish the call between the target UE 760 and the transferee UE 790. By transmitting the SIP re-INVITE message over the existing second dialog instead of transmitting a new SIP INVITE message from the target UE 760 to the transferee UE 790, the AS 780 is capable of transferring the call regardless of a state of the call. For example, AS 780 can transfer the call while the call remains in an active state (e.g., without placing the call on hold), thereby reducing call transfer time and improving a user experience.

Although FIG. 9 shows example blocks of a method of wireless communication, in some aspects, the method may include additional blocks, fewer blocks, different blocks, or differently arranged blocks than those shown in FIG. 9. Additionally, or alternatively, two or more blocks shown in FIG. 9 may be performed in parallel.

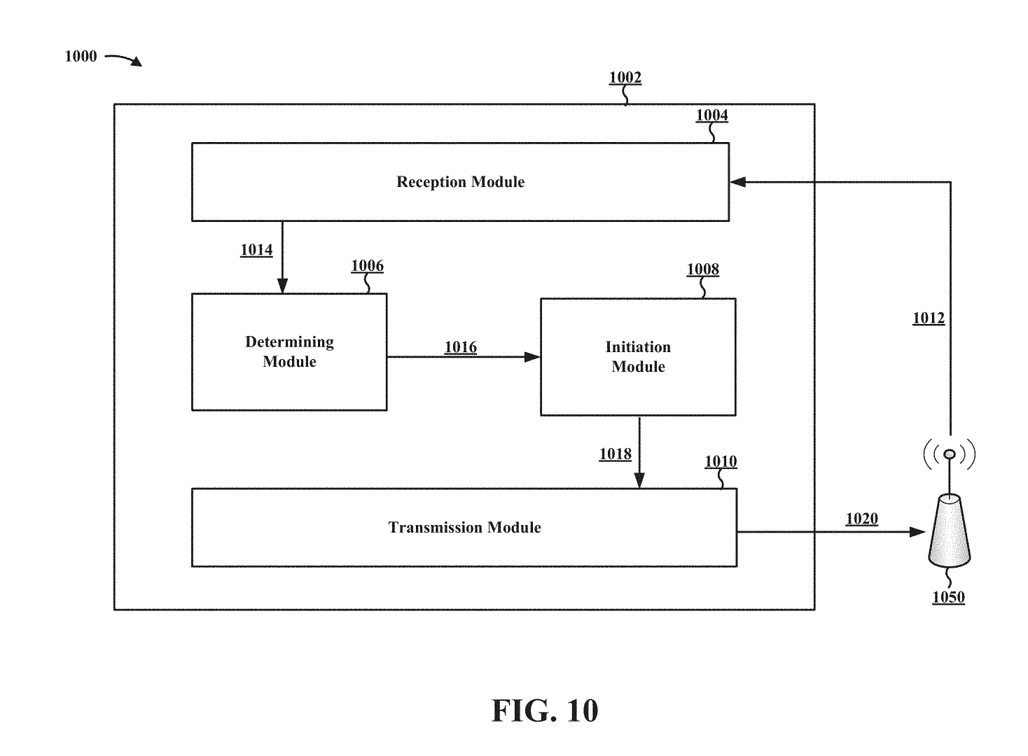

FIG. 10 is a conceptual data flow diagram 1000 illustrating the data flow between different modules/means/components in an example apparatus 1002. The apparatus may be a UE, such as UE 102, UE 206, UE 650, transferor UE 770, or the like. In some aspects, the apparatus includes a reception module 1004, a determining module 1006, an initiation module 1008, and/or a transmission module 1010.

The reception module 1004 may receive data 1012 from an eNB 1050, such as data transmitted by an application server. In some aspects, the reception module 1004 may provide data 1014 to the determining module 1006, such as information included in a dialog event package, information indicating whether a target UE is available and/or registered with an IMS network, or the like. The determining module 1006 may determine that the transferor UE is to transfer a call from the first UE to a second UE (e.g., based at least in part on user input and/or data 1014).

The determining module 1006 may provide data 1016 to the initiation module 1008. For example, the data 1016 may indicate that the transferor UE is to initiate a call transfer procedure. The initiation module 1008 may initiate the call transfer procedure while the call is in an active state. For example, the initiation module 1008 may initiate the call transfer procedure by providing data 1018 (e.g., a SIP REFER message) to the transmission module 1010. The transmission module 1010 may provide data 1020 (e.g., the SIP REFER message) to eNB 1050 for transmission to the application server and/or another device.

The apparatus may include additional modules that perform each of the blocks of the algorithm in the aforementioned flow chart of FIG. 8. As such, each block in the aforementioned flow chart of FIG. 8 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

The number and arrangement of modules shown in FIG. 10 are provided as an example. In practice, there may be additional modules, fewer modules, different modules, or differently arranged modules than those shown in FIG. 10. Furthermore, two or more modules shown in FIG. 10 may be implemented within a single module, or a single module shown in FIG. 10 may be implemented as multiple, distributed modules. Additionally, or alternatively, a set of modules (e.g., one or more modules) shown in FIG. 10 may perform one or more functions described as being performed by another set of modules shown in FIG. 10.

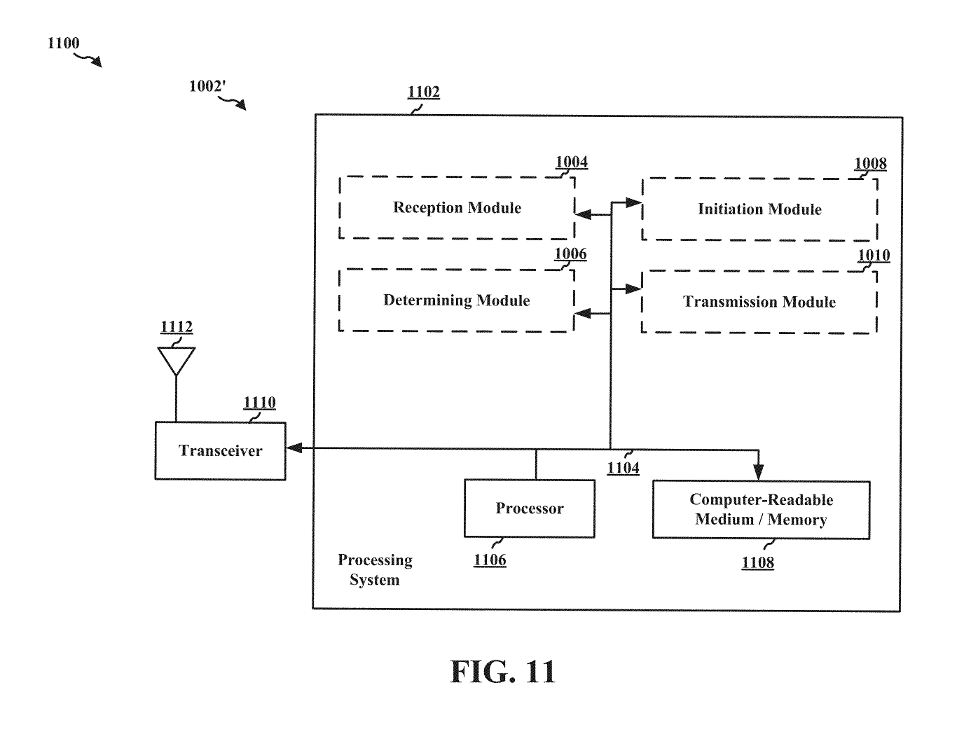

FIG. 11 is a diagram 1100 illustrating an example of a hardware implementation for an apparatus 1002′ employing a processing system 1102. The processing system 1102 may be implemented with a bus architecture, represented generally by the bus 1104. The bus 1104 may include any number of interconnecting buses and bridges depending on the specific application of the processing system 1102 and the overall design constraints. The bus 1104 links together various circuits including one or more processors and/or hardware modules, represented by the processor 1106, the modules 1004, 1006, 1008, and 1010, and the computer-readable medium/memory 1108. The bus 1104 may also link various other circuits such as timing sources, peripherals, voltage regulators, and power management circuits, which are well known in the art, and therefore, will not be described any further.

The processing system 1102 may be coupled to a transceiver 1110. The transceiver 1110 is coupled to one or more antennas 1112. The transceiver 1110 provides a means for communicating with various other apparatus over a transmission medium. The transceiver 1110 receives a signal from the one or more antennas 1112, extracts information from the received signal, and provides the extracted information to the processing system 1102, specifically the reception module 1004. In addition, the transceiver 1110 receives information from the processing system 1102, specifically the transmission module 1010, and based at least in part on the received information, generates a signal to be applied to the one or more antennas 1112. The processing system 1102 includes a processor 1106 coupled to a computer-readable medium/memory 1108. The processor 1106 is responsible for general processing, including the execution of software stored on the computer-readable medium/memory 1108. The software, when executed by the processor 1106, causes the processing system 1102 to perform the various functions described supra for any particular apparatus. The computer-readable medium/memory 1108 may also be used for storing data that is manipulated by the processor 1106 when executing software. The processing system further includes at least one of the modules 1004, 1006, 1008, and/or 1010. The modules may be software modules running in the processor 1106, resident/stored in the computer readable medium/memory 1108, one or more hardware modules coupled to the processor 1106, or some combination thereof. The processing system 1102 may be a component of the UE 650 and may include the memory 660 and/or at least one of the TX processor 668, the RX processor 656, and the controller/processor 659.

In one configuration, the apparatus 1302/1302′ for wireless communication includes means for determining that a first UE is to transfer a call from the first UE to a second UE that shares an MDN with the first UE, and means for initiating a call transfer procedure to transfer the call from the first UE to the second UE while the call is in an active state. The aforementioned means may be one or more of the aforementioned modules of the apparatus 1002 and/or the processing system 1102 of the apparatus 1002′ configured to perform the functions recited by the aforementioned means. As described supra, the processing system 1102 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

FIG. 11 is provided as an example. Other examples are possible and may differ from what was described in connection with FIG. 11.

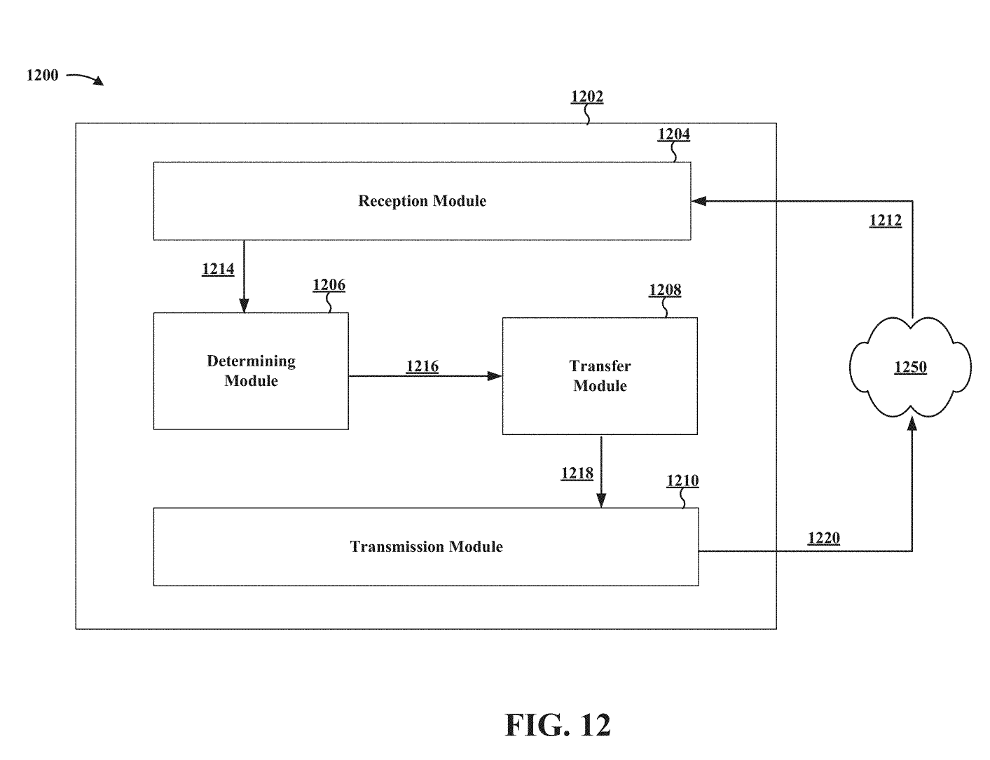

FIG. 12 is a conceptual data flow diagram 1200 illustrating the data flow between different modules/means/components in an example apparatus 1202. The apparatus may be an application server, such as AS 780, or the like. In some aspects, the apparatus includes a reception module 1204, a determining module 1206, a transfer module 1208, and/or a transmission module 1210.

The reception module 1204 may receive data 1212 from a network 1250 (e.g., via an eNB), such as data transmitted by one or more UEs, such as a transferor UE, a transferee UE, and/or a target UE. In some aspects, the reception module 1204 may provide data 1214 to the determining module 1206, such as information included in a SIP REFER message received from a transferor UE. The determining module 1206 may determine that the application server is to transfer a call from a first UE to a second UE (e.g., based at least in part on data 1214).

The determining module 1206 may provide data 1216 to the transfer module 1208. For example, the data 1216 may indicate that the application server is to perform a call transfer procedure. The transfer module 1208 may perform a call transfer procedure to transfer the call from the first UE to the second UE while the call is in an active state. For example, the transfer module 1208 may transfer the call by providing data 1218 (e.g., a SIP re-INVITE message, a SIP INVITE message without SDP information, etc.) to the transmission module 1210. The transmission module 1210 may provide data 1220 (e.g., the SIP re-INVITE message, the SIP INVITE message without SDP information) to network 1250 for transmission to a UE (e.g., via an eNB).

The apparatus may include additional modules that perform each of the blocks of the algorithm in the aforementioned flow chart of FIG. 9. As such, each block in the aforementioned flow chart of FIG. 9 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

The number and arrangement of modules shown in FIG. 12 are provided as an example. In practice, there may be additional modules, fewer modules, different modules, or differently arranged modules than those shown in FIG. 12. Furthermore, two or more modules shown in FIG. 12 may be implemented within a single module, or a single module shown in FIG. 12 may be implemented as multiple, distributed modules. Additionally, or alternatively, a set of modules (e.g., one or more modules) shown in FIG. 12 may perform one or more functions described as being performed by another set of modules shown in FIG. 12.

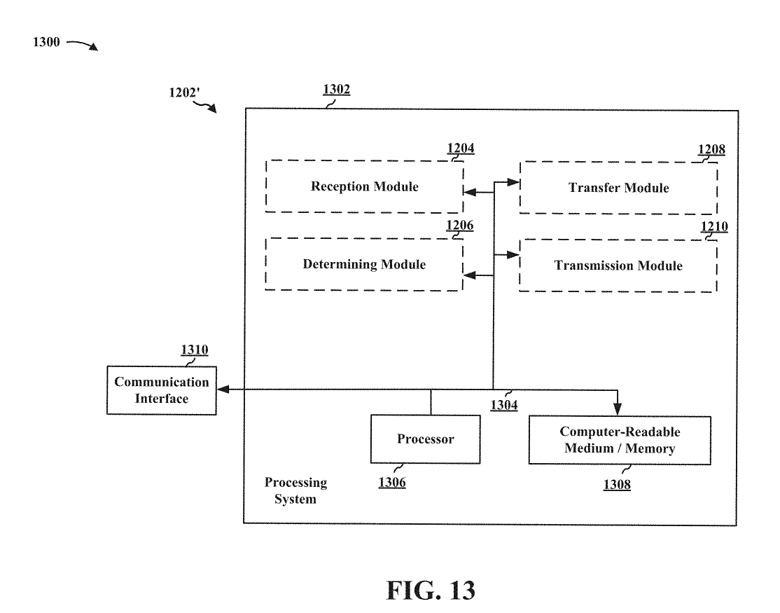

FIG. 13 is a diagram 1300 illustrating an example of a hardware implementation for an apparatus 1202′ employing a processing system 1302. The processing system 1302 may be implemented with a bus architecture, represented generally by the bus 1304. The bus 1304 may include any number of interconnecting buses and bridges depending on the specific application of the processing system 1302 and the overall design constraints. The bus 1304 links together various circuits including one or more processors and/or hardware modules, represented by the processor 1306, the modules 1204, 1206, 1208, and 1210, and the computer-readable medium/memory 1308. The bus 1304 may also link various other circuits such as timing sources, peripherals, voltage regulators, and power management circuits, which are well known in the art, and therefore, will not be described any further.

The processing system 1302 may be coupled to a communication interface 1310. The communication interface 1310 provides a means for communicating with various other apparatus over a transmission medium. The communication interface 1310 receives a signal via the transmission medium, extracts information from the received signal, and provides the extracted information to the processing system 1302, specifically the reception module 1204. In addition, the communication interface 1310 receives information from the processing system 1302, specifically the transmission module 1210, and based at least in part on the received information, generates a signal to be applied to the transmission medium. The processing system 1302 includes a processor 1306 coupled to a computer-readable medium/memory 1308. The processor 1306 is responsible for general processing, including the execution of software stored on the computer-readable medium/memory 1308. The software, when executed by the processor 1306, causes the processing system 1302 to perform the various functions described supra for any particular apparatus. The computer-readable medium/memory 1308 may also be used for storing data that is manipulated by the processor 1306 when executing software. The processing system further includes at least one of the modules 1204, 1206, 1208, and/or 1210. The modules may be software modules running in the processor 1306, resident/stored in the computer readable medium/memory 1308, one or more hardware modules coupled to the processor 1306, or some combination thereof.

In one configuration, the apparatus 1202/1202′ for wireless communication includes means for determining that a call is to be transferred from a first UE to a second UE, and means for transferring the call from the first UE to the second UE while the call is in an active state. The aforementioned means may be one or more of the aforementioned modules of the apparatus 1202 and/or the processing system 1302 of the apparatus 1202′ configured to perform the functions recited by the aforementioned means.

FIG. 13 is provided as an example. Other examples are possible and may differ from what was described in connection with FIG. 13.

It is understood that the specific order or hierarchy of blocks in the processes/flow charts disclosed is an illustration of example approaches. Based upon design preferences, it is understood that the specific order or hierarchy of blocks in the processes/flow charts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
determining, by a first user equipment (UE), that the first UE is to transfer a call from the first UE to a second UE, wherein the first UE and the second UE share a mobile device number (MDN); and
initiating, by the first UE, a call transfer procedure to transfer the call from the first UE to the second UE while the call is in an active state.

2. The method of claim 1, wherein initiating the call transfer procedure comprises:
initiating the call transfer procedure based at least in part on determining that the second UE is available to receive the call.

3. The method of claim 2, wherein the determination that the second UE is available to receive the call is based at least in part on a SIP OPTIONS query response received from the second UE.

4. The method of claim 1, wherein initiating the call transfer procedure comprises:
initiating the call transfer procedure based at least in part on determining that the second UE is registered with an Internet Protocol Multimedia Subsystem (IMS) network.

5. The method of claim 1, wherein initiating the call transfer procedure comprises:
initiating the call transfer procedure based at least in part on determining that the call is transferable.

6. The method of claim 5, wherein the determination that the call is transferable is based at least in part on a dialog event package received by the first UE.

7. The method of claim 1, wherein initiating the call transfer procedure comprises:
transmitting a session initiation protocol (SIP) REFER message, that identifies the second UE, to an application server.

8. An apparatus for wireless communication, comprising:
a memory; and
at least one processor coupled to the memory and configured to:
determine that the apparatus is to transfer a call from the apparatus to a target apparatus, wherein the apparatus and the target apparatus share a mobile device number (MDN); and
initiate a call transfer procedure to transfer the call from the apparatus to the target apparatus while the call is in an active state.

9. The apparatus of claim 8, wherein the at least one processor, when initiating the call transfer procedure, is configured to:
initiate the call transfer procedure based at least in part on determining that the target apparatus is available to receive the call.

10. The apparatus of claim 9, wherein the determination that the target apparatus is available to receive the call is based at least in part on a SIP OPTIONS query response received from the target apparatus.

11. The apparatus of claim 8, wherein the at least one processor, when initiating the call transfer procedure, is configured to:
initiate the call transfer procedure based at least in part on determining that the target apparatus is registered with an Internet Protocol Multimedia Subsystem (IMS) network.

12. The apparatus of claim 8, wherein the at least one processor, when initiating the call transfer procedure, is configured to:
initiate the call transfer procedure based at least in part on determining that the call is transferable.

13. The apparatus of claim 12, wherein the determination that the call is transferable is based at least in part on a dialog event package received by the apparatus.

14. The apparatus of claim 8, wherein the at least one processor, when initiating the call transfer procedure, is configured to:
transmit a session initiation protocol (SIP) REFER message, that identifies the target apparatus, to an application server.

15. A method of wireless communication, comprising:
determining, by an application server, that a call is to be transferred from a first user equipment (UE) to a second UE, wherein the first UE and the second UE share a mobile device number (MDN); and
transferring, by the application server, the call from the first UE to the second UE while the call is in an active state.

16. The method of claim 15, wherein transferring the call comprises:
transmitting a session initiation protocol (SIP) re-INVITE message to a third UE that is connected on the call with the first UE.

17. The method of claim 16, wherein the call is associated with a dialog between the application server and the third UE; and
wherein the SIP re-INVITE message is transmitted via the dialog.

18. The method of claim 16, further comprising:
receiving a session description protocol (SDP) answer message from the third UE based at least in part on transmitting the SIP re-INVITE message to the third UE; and
transmitting, to the second UE, a SIP acknowledgement (ACK) message that includes the SDP answer.

19. The method of claim 15, wherein determining that the call is to be transferred comprises:
determining that the call is to be transferred from the first UE to the second UE based at least in part on receiving a session initiation protocol (SIP) REFER message, that identifies the second UE, from the first UE.

20. The method of claim 15, wherein transferring the call comprises:
transmitting a session initiation protocol (SIP) INVITE message, without session description protocol (SDP) information, to the second UE;
receiving an SDP offer from the second UE;
transmitting a SIP re-INVITE message to a third UE that is on the call with the first UE;
receiving an SDP answer from the third UE; and
transmitting, to the second UE, a SIP acknowledgement (ACK) message that includes the SDP answer.

21. The method of claim 20, wherein the SIP re-INVITE message includes the SDP offer.

22. The method of claim 15, wherein transferring the call from the first UE to the second UE while the call is in the active state comprises:
transferring the call without placing the call on hold.

23. An application server for wireless communication, comprising:
a memory; and
at least one processor coupled to the memory and configured to:
determine that a call is to be transferred from a first user equipment (UE) to a second UE, wherein the first UE and the second UE share a mobile device number (MDN); and
transfer the call from the first UE to the second UE while the call is in an active state.

24. The application server of claim 23, wherein the at least one processor, when transferring the call, is configured to:
transmit a session initiation protocol (SIP) re-INVITE message to a third UE that is connected on the call with the first UE.

25. The application server of claim 24, wherein the call is associated with a dialog between the application server and the third UE; and
wherein the SIP re-INVITE message is transmitted via the dialog.

26. The application server of claim 24, wherein the at least one processor is further configured to:
receive a session description protocol (SDP) answer message from the third UE based at least in part on transmitting the SIP re-INVITE message to the third UE; and
transmit, to the second UE, a SIP acknowledgement (ACK) message that includes the SDP answer.

27. The application server of claim 23, wherein the at least one processor, when determining that the call is to be transferred, is configured to:
determine that the call is to be transferred from the first UE to the second UE based at least in part on receiving a session initiation protocol (SIP) REFER message, that identifies the second UE, from the first UE.

28. The application server of claim 23, wherein the at least one processor, when transferring the call, is configured to:
transmit a session initiation protocol (SIP) INVITE message, without session description protocol (SDP) information, to the second UE;
receive an SDP offer from the second UE;
transmit a SIP re-INVITE message to a third UE that is on the call with the first UE;
receive an SDP answer from the third UE; and
transmit, to the second UE, a SIP acknowledgement (ACK) message that includes the SDP answer.

29. The application server of claim 28, wherein the SIP re-INVITE message includes the SDP offer.

30. The application server of claim 23, wherein the at least one processor, when transferring the call, is configured to:
transfer the call without placing the call on hold.
